(19) United States
(12) Patent Application Publication
(10) Pub. No.: US 2023/0354285 A1
(43) Pub. Date: Nov. 2, 2023

(54) METHODS, DEVICES, AND SYSTEMS FOR CONFIGURING GROUP-BASED BANDWIDTH PART SWITCH

(71) Applicant: ZTE Corporation, Shenzhen (CN)

(72) Inventors: Wenting LI, Shenzhen (CN); He HUANG, Shenzhen (CN)

(73) Assignee: ZTE Corporation, Shenzhen (CN)

(21) Appl. No.: 18/344,283

(22) Filed: Jun. 29, 2023

Related U.S. Application Data
(63) Continuation of application No. PCT/CN2021/087415, filed on Apr. 15, 2021.

(51) Int. Cl. H04W 72/0453; H04W 72/23

(52) U.S. Cl. CPC H04W 72/0453; H04W 72/23

(57) ABSTRACT

The present disclosure describes methods, systems and devices for configuring signal resource for configuring group-based bandwidth part (BWP) switch. One method includes configuring a group-based BWP switch for a user equipment (UE) by: sending, by the base station, a configuration comprising at least one BWP group to the UE, wherein each BWP group of the at least one BWP group comprises at least one BWP of at least one cell in a band combination (BC); and receiving, by the base station, a configuration confirm message from the UE about the configuration result. Another method includes receiving, by a UE, a configuration comprising at least one BWP group from a base station, wherein each BWP group of the at least one BWP group comprises at least one BWP of at least one cell in a BC; and configuring, by the UE, the configuration received from the base station.

### TECHNICAL FIELD

The present disclosure is directed generally to wireless communications. Particularly, the present disclosure relates to methods, devices, and systems for configuring group-based bandwidth part (BWP) switch.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

In a wireless communication, a bandwidth part (BWP) concept was introduced to the wireless communication system. For each cell, a network may configure multiple BWPs though only one BWP can be activated. Meanwhile, a user equipment (UE) may report its capability according to the network's requirements. For a dual connection (DC) and/or carrier aggregation (CA), the network may configure the BWP of each band entry according to the UE band combination (BC) capability.

There are problems or issues associated with the BWP management system. The present disclosure may address at least one of issues/problems associated with the existing system and describes various embodiments, thus improving the performance of the wireless communication.

### SUMMARY

This document relates to methods, systems, and devices for wireless communication and more specifically, for configuring group-based bandwidth part (BWP) switch.

In one embodiment, the present disclosure describes a method for wireless communication. The method includes configuring, by a base station, a group-based bandwidth part (BWP) switch for a user equipment (UE) by sending, by the base station, a configuration comprising at least one BWP group to the UE, wherein each BWP group of the at least one BWP group comprises at least one BWP of at least one cell in a band combination (BC); and receiving, by the base station, a configuration confirm message from the UE about the configuration result.

In another embodiment, the present disclosure describes a method for wireless communication. The method includes receiving, by a user equipment (UE), a configuration comprising at least one bandwidth part (BWP) group from a base station, wherein each BWP group of the at least one BWP group comprises at least one BWP of at least one cell in a band combination (BC); and configuring, by the UE, the configuration received from the base station.

In another embodiment, the present disclosure describes a method for wireless communication. The method includes receiving, by the RAN node, information that a simple procedure indication; and avoiding, by the RAN node upon receiving the information, to trigger a specific procedure.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example of a wireless communication system include more than one network nodes and one or more user equipment.

FIG. 2 shows an example of a network node.

FIG. 3 shows an example of a user equipment.

FIG. 4A shows a flow diagram of a method for wireless communication.

FIG. 4B shows a schematic diagram of a method for wireless communication.

FIG. 4C shows a schematic diagram of a method for wireless communication.

FIG. 4D shows a schematic diagram of a method for wireless communication.

FIG. 5 shows a flow diagram of a method for wireless communication.

FIG. 6 shows a schematic diagram of an exemplary embodiment for wireless communication.

FIG. 7 shows a schematic diagram of an exemplary embodiment for wireless communication.

FIG. 8 shows a schematic diagram of an exemplary embodiment for wireless communication.

FIG. 9 shows a schematic diagram of an exemplary embodiment for wireless communication.

FIG. 10 shows a schematic diagram of an exemplary embodiment for wireless communication.

FIG. 11 shows a schematic diagram of an exemplary embodiment for wireless communication.

FIG. 12 shows a schematic diagram of an exemplary embodiment for wireless communication.

FIG. 13 shows a schematic diagram of an exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for configuring group-based bandwidth part (BWP) switch.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfill the requirements from different industries and users.

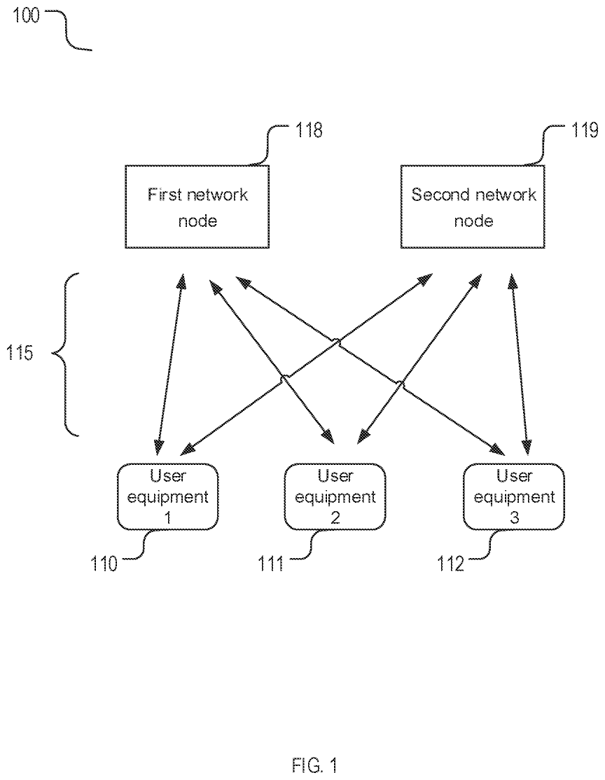

The present disclosure describes various embodiments for configuring group-based bandwidth part (BWP) switch. FIG. 1 shows a wireless communication system 100 including more than one wireless network nodes (118 and 119 ) and one or more user equipment (UE) (110, 111, and 112).

For the 5th Generation mobile communication technology, a UE 110, for example, a smart phone, may connect to one network node 118, for example, a radio access network (RAN) node and/or a core network (CN) node, or may connect to more than one network nodes (118 and 119), for example, two RAN nodes and/or two CN nodes.

The wireless network node (118 and 119) may include a network base station, which may be a nodeB (NB, e.g., a gNB) in a mobile telecommunications context. Each of the UE (110, 111, and 112) may wirelessly communicate with the wireless network node (118 and 119) via one or more radio channels 115. For example, the first UE 110 may wirelessly communicate with the first network node 118 via a channel including a plurality of radio channels during a certain period of time; during another period of time, the first UE 110 may wirelessly communicate with the second network node 119 via a channel including a plurality of radio channels.

In a wireless communication, a bandwidth part (BWP) concept may be introduced to the wireless communication system. For each cell, a network may configure multiple BWPs though only one BWP can be activated. Meanwhile, a user equipment (UE) may report its capability according to the network's requirements. For a dual connection (DC) and/or carrier aggregation (CA), the network may configure the BWP of each band entry according to the UE band combination (BC) capability.

The network may switch the BWP by at least one of a radio resource control (RRC) signaling, download control information (DCI), a BWP inactivity timer, or a random access (RA) procedure. The RRC signaling may have a longest delay. With all of these methods, each BWP may be activated or deactivated individually by its corresponding control information. For example, in the DCI, there may be a bandwidth part indicator (BWP indicator) to indicate which BWP may be activated and/or inactivated of the current serving cell.

Table 1 shows an example of values of BWP indicator field.

TABLE 1
Value of BWP Indicator Field

| Value of BWP | |
|---|---|
| indicator field | |
| 2 bits | Bandwidth part |
| 00 | Configured BWP with BWP-Id = 1 |
| 01 | Configured BWP with BWP-Id = 2 |
| 10 | Configured BWP with BWP-Id = 3 |
| 11 | Configured BWP with BWP-Id = 4 |

In some wireless communication systems, a dormancy BWP may be introduced, in which a cell group concept may be introduced. The network may switch a group of secondary cells (SCells) into the respective dormant BWP through the DCI. When the dormant BWP for the Scell is configured, the network may configure the dormant cell group it belongs to, then in the DCI, a bitmap may be introduced for the dormant feature. The bitmap size may be equal to the number of groups of configured SCells, where each bit of the bitmap corresponds to a group of SCells. In one implementations, this group-based concept may be used only for the dormant BWP.

In some other wireless communication systems, a current UE BC capability may be for any combination of the configured BWP. All of the possible combinations of the configured BWPs on the different bands may satisfy the requirement of the reported UE BC capability. This configuration may affect the system performance seriously.

In this disclosure we consider how to configure and manage the BWPs more efficiently based on the above description.

The present disclosure describes various embodiments for configuring and/or managing the BWPs more efficiently for at least one scenario, including but not limited to the scenarios as discussed above. The present disclosure describes methods, systems, and storage medium for configuring group-based bandwidth part (BWP) switch.

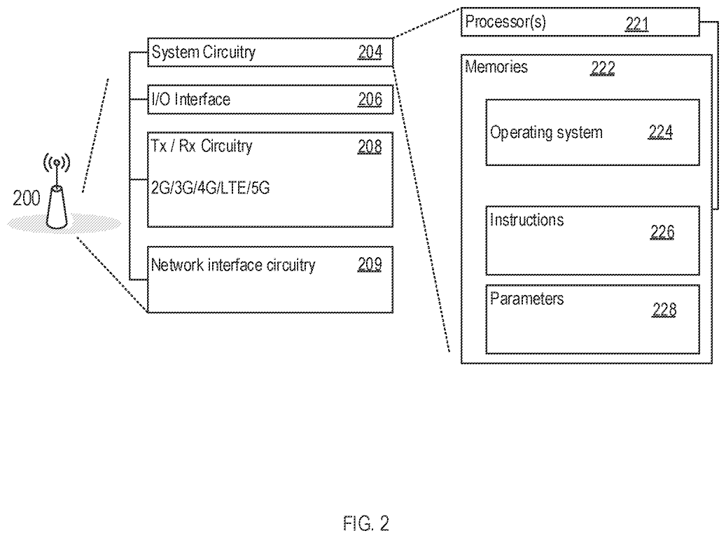

FIG. 2 shows an example of electronic device 200 to implement a network node or network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

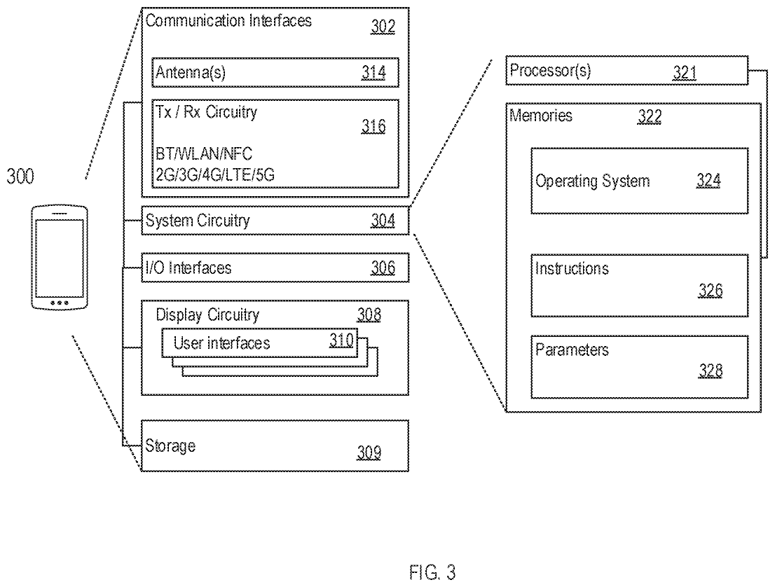

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE) , and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes various embodiments, which may be implemented, partly or totally, on the network base station and/or the user equipment described above in FIGS. 2-3.

Some embodiments may include at least one of the following: that a network may define and/or configure one or more groups of BWPs; the network may switch a group of BWPs simultaneously by at least one of a DCI, MAC CE, or RRC signaling; and/or as a further enhancement, a UE may report the BC capabilities for the active BWPs, and the network may define, configure, and/or switch active BWP groups based on the BC capabilities for the active BWPs.

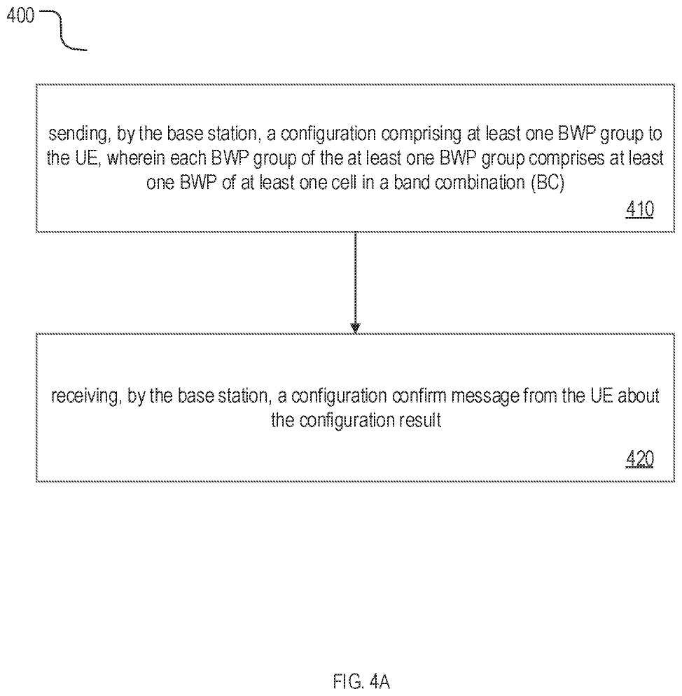

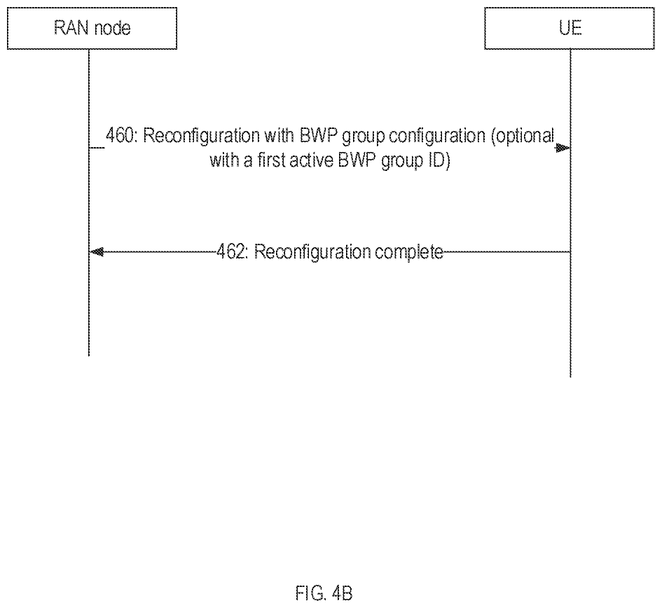

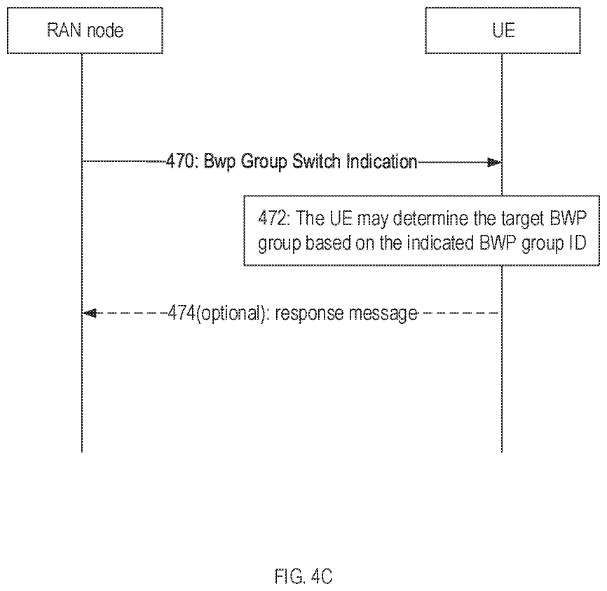

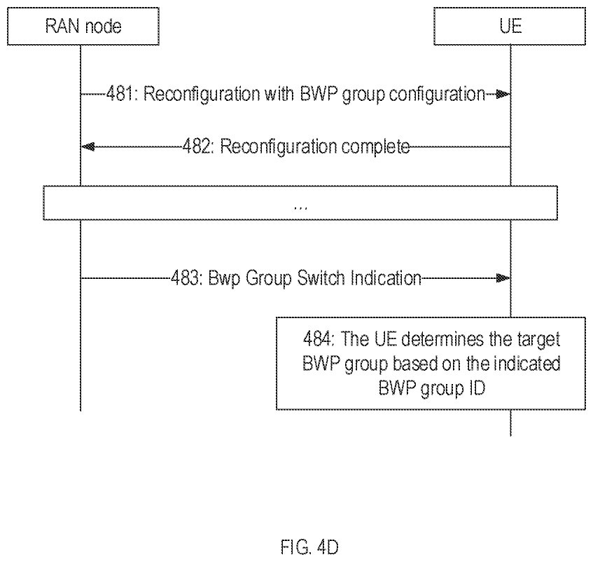

Referring to FIG. 4A, the present disclosure describes embodiments of a method 400 for configuring, by a base station, a group-based bandwidth part (BWP) switch for a user equipment (UE). The method 400 may include a portion or all of the following steps: step 410: sending, by the base station, a configuration comprising at least one BWP group to the UE, wherein each BWP group of the at least one BWP group comprises at least one BWP of at least one cell in a band combination (BC); and step 420: receiving, by the base station, a configuration confirm message from the UE about the configuration result.

In one implementation, the base station may also indicate a first active BWP group to the UE. In another implementation, the base station may send the configuration comprising the at least one BWP group to the UE in a RRC signaling.

Referring to FIG. 4B, in step 460, the network (e.g., a RAN node) may send the BWP group configuration to the UE through a RRC reconfiguration message. In step 462, when the UE can accept the configuration, the UE may send a reconfiguration complete message to the network.

In one implementation, in the step 460, the network may also indicate the first active BWP group ID, then the UE shall active the BWP of each cell that indicated in the first active BWP group ID.

Referring to FIG. 4C, in step 470, the network (e.g, a RAN node) may send the BWP group switch indication to the UE. In step 472, the UE may determine the target BWP group based on the indicated BWP group ID. n one implementation, the UE may determine the detail BWP of the target BWP group also based on the previous received BWP group configuration. Optionally in another implementation, referring to step 474, the UE may optionally send a response message to the network.

In FIG. 4C, the indication message in the step 470 may be at least one of a MAC CE, a DCI, or a RRC signaling, for example but not limited to, a RRCConnection Reconfiguration message.

Referring to FIG. 4D, the network (e.g., a RAN node) may configure the BWP group(s) to the UE first (in step 481). The network may also indicate the target group ID to the UE (in step 483). Then, in step 484, the UE may determine the detail BWP of the target BWP group based on the previous received BWP group configuration in the step 481 and the target group ID in the step 483.

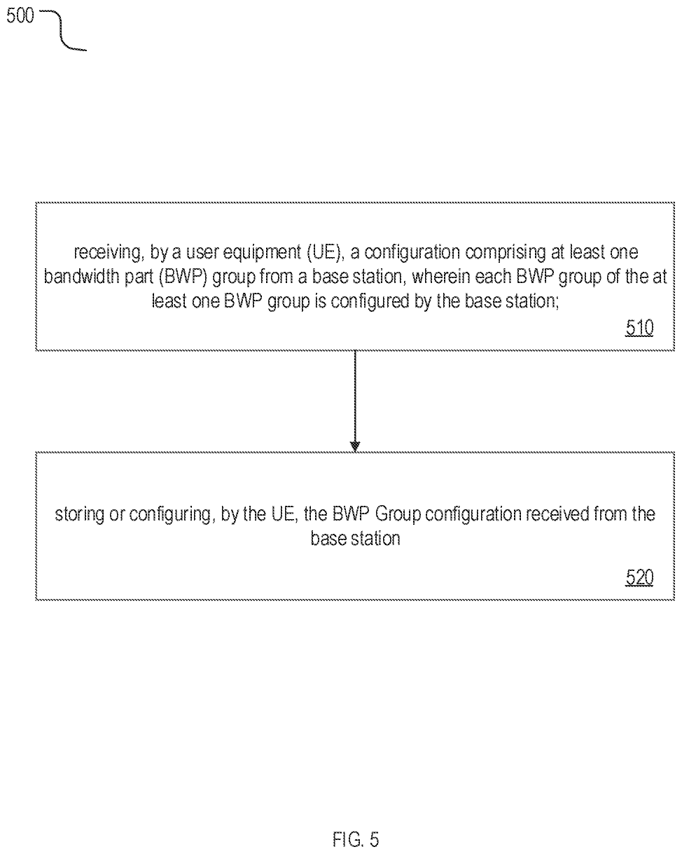

Referring to FIG. 5, the present disclosure describes embodiments of a method 500 for wireless communication. The method 500 may include a portion or all of the following steps: step 510: receiving, by a user equipment (UE), a configuration comprising at least one bandwidth part (BWP) group from a base station, wherein each BWP group of the at least one BWP group is configured by the base station; and step 520: storing or configuring, by the UE, the BWP Group configuration received from the base station.

In one implementation, each BWP group of the at least one BWP group comprises at least one BWP of at least one cell in a band combination (BC).

In another implementation, the at least one BWP group comprises a default BWP group.

In another implementation, for a BWP group of the at least one BWP group, the base station configures a BWP group identifier (ID) corresponding to the BWP group comprising at least one BWP.

In another implementation, for a BWP, the base station configures that the BWP belongs to at least one BWP group ID corresponding to a BWP group of the at least one BWP group.

In another implementation, the at least one BWP in the BWP group ID corresponds to at least one cell included in at least one of a master cell group (MCG) or a secondary cell group (SCG).

In another implementation, the base station configures at least one cell group; and for each cell group of the at least one cell group, the base station configures the at least one BWP group corresponding to the each cell group of the at least one cell group.

In another implementation, the base station configures implicitly an index to each BWP group of the at least one BWP group, the index indicating a specific BWP for a specific cell.

In another implementation, the index comprises N*M bits, wherein N corresponds to a number of cells, M corresponds to a number of BWPs.

In another implementation, in response to the number of BWPs being 4, M equals to 3; and in response to the number of BWPs being 3, M equals to 2.

In various embodiments, a network may define and/or configure one or more BWP groups. For example, in a BWP group, the BWPs are from the different cells. For another example, a BWP group can including all of the cells in a BC, or part of cells in a BC.

Some embodiments may include one or more of the following methods for defining and/or configuring one or more BWP groups: Method 1: For each BWP group, define the included BWPs of different cells explicitly, or for each BWP, define its related groups IDs explicitly; Method 2: Define cells group first and then define the BWP group for each cell group; and Method 3: Define the mapping relationship between the BWP of each cell and the group ID implicitly.

In some implementations, the network may send the BWP group definition and/or configuration to the UE in one or more of the following means.

For the method 1, this BWP group definition/configuration may be from either Group ID perspective or from the BWP perspective. For the group ID perspective, the network indicates which BWPs are included for a Group ID. For the BWP perspective, the network indicates a certain BWP belongs to which groups IDs.

For the method 2, the network may indicate the cell group information to the UE. For each cell, the network may indicate which cell group it belongs to. In another implementation, similar method as the method 1 and/or 3 may be adopted to indicate the BWP group definition/configuration in each cell group. In another implementation, for the case that a cell may belong to different cell groups, for each BWP, the network may indicate which cell group and which BWP group it belongs to.

For the method 3, the network may send the BWP group definition and/or configuration to the UE in an implicit indication method.

In another implementation, the network may also define a default BWP group.

In another implementation, the BWPs in a group ID may be in the same cell Group, e.g., master cell group (MCG) or a secondary cell group (SCG).

In another implementation, the BWPs in a group ID may be from two or more different cell Groups.

One example for a BWP group definition and configuration in method 1 is described. There may be 3 cells in a BC: Cell A, Cell B, and Cell C, respectively. For each Cell, 3 BWPs may be configured as below:

$$BWPConfig ⇒ [ \begin{matrix}C e l l A & C e l l B & C e l l C \\ B W {P}_{1 A} & B W {P}_{1 B} & B W {P}_{1 C} \\ B W {P}_{2 A} & B W {P}_{2 B} & B W {P}_{2 C} \\ B W {P}_{3 A} & B W {P}_{3 B} & B W {P}_{3 C}\end{matrix} ]$$

The network may define some BWP groups as Table 2.

TABLE 2
One Example of BWP Groups

| BWP Group | | | |
|---|---|---|---|
| ID | Cell A | Cell B | Cell C |
| 1 | 1A | 1B | |
| 2 | 1A | 2B | 3C |
| 3 | | 2B | 1C |
| 4 | 3A | 3B | 2C |

In another implementation, when configure the BWP for each cell, the network may also indicate the related BWP Group IDs in each BWP configuration, the related Group IDs may be expressed by a bitmap or a list of index, as illustrated below:

| ServingCellConfig ::= | | SEQUENCE { |
|---|---|---|
| initialDownlinkBWP | | BWP- |
| DownlinkDedicated | OPTIONAL, | -- Need M |

| | |
|---|---|
| downlinkBWP-ToAddModList | SEQUENCE (SIZE |

(1. .maxNrofBWPs) ) OF BWP-Downlink
OPTIONAL, -- Need N
}

| BWP-Downlink ::= | | SEQUENCE { |
|---|---|---|
| bwp-Id | BWP-Id, | |
| bwp-Common | BWP-DownlinkCommon | OPTIONAL, |

-- Cond SetupOtherBWP

| | | |
|---|---|---|
| bwp-Dedicated | BWP-DownlinkDedicated | OPTIONAL, |

-- Cond SetupOtherBWP
. . . }
-- GroupID index list

| | | |
|---|---|---|
| BWP-DownlinkDedicated | ::= | SEQUENCE { |

| | |
|---|---|
| groupIDList | SEQUENCE (SIZE (1. .maxGroupID) ) OF |

groupID
}
---Or Group ID bitmap

| | | |
|---|---|---|
| BWP-DownlinkDedicated | ::= | SEQUENCE { |

| | |
|---|---|
| groupIDBitMap | :: = BIT STRING |

(SIZE (maxGroup ID) )
}

In one implementation, for the cell A, for the BWP1A, it will indicate group ID ½ to the UE.

In another implementation, for the BWP 3A, it will indicate group ID 4 to the UE.

In another implementation, a similar logic may also be adopted for cell B/C, the group ID may also start with 0.

In another implementation, the above example is from the BWP perspective, it may also be configured from the group ID perspective.

Another example for BWP group definition and configuration in method 2 is described. The cells may be divided into different groups, and then the BWP group is defined for each Cell Group. There are 4 cells in a BC, Cell A, Cell B, Cell C, and Cell D, respectively, with BWP configuration as below:

$$BWPConfig ⇒ [ \begin{matrix}C e l l A & C e l l B & C e l l C & C e l l D \\ B W {P}_{1 A} & B W {P}_{1 B} & B W {P}_{1 C} & B W {P}_{1 D} \\ B W {P}_{2 A} & B W {P}_{2 B} & B W {P}_{2 C} & B W {P}_{2 D} \\ B W {P}_{3 A} & B W {P}_{3 B} & B W {P}_{3 C} & B W {P}_{3 D}\end{matrix} ]$$

In one implementation, they may be divided into 2 groups: the cell A/B belongs to the Cell Group 1 while the cell C/D belongs to the Cell group 2; and then the BWP group for the cell group 1 may be defined as Table 3 and/or Table 4.

TABLE 3
BWP Groups for a Cell Group 1

| BWP Group ID | Cell A | Cell B |
|---|---|---|
| 1 | 1A | 1B |
| 2 | 1A | 2B |
| 3 | 3A | 3B |

TABLE 4
BWP Groups for a Cell Group 2

| BWP Group ID | Cell C | Cell D |
|---|---|---|
| 1 | 1C | 2D |
| 2 | 2C | 1D |

In one implementation, the Asn.1 coding may be described as below:

| | |
|---|---|
| ServingCellConfig ::= | SEQUENCE { |
| initialDownlinkBWP | BWP- |

DownlinkDedicated

| | |
|---|---|
| downlinkBWP-ToAddModList | SEQUENCE (SIZE |

(1. .maxNrofBWPs) ) OF BWP-Downlink
OPTIONAL, -- Need N

| | |
|---|---|
| cellGroupID | INTEGER |

| | |
|---|---|
| (1. .MaxCellGroup) | OPTIONAL |

}

| BWP-Downlink ::= | | SEQUENCE { |
|---|---|---|
| bwp-Id | BWP-Id, | |
| bwp-Common | BWP-DownlinkCommon | OPTIONAL, |

-- Cond SetupOtherBWP

| | | |
|---|---|---|
| bwp-Dedicated | BWP-DownlinkDedicated | OPTIONAL, |

-- Cond SetupOtherBWP
. . . }
-- GroupID index list

| | | |
|---|---|---|
| BWP-DownlinkDedicated | ::= | SEQUENCE { |

| | |
|---|---|
| groupIDList | SEQUENCE (SIZE (1. .maxGroupID) ) OF |

groupID
}
---Or Group ID bitmap

| | | |
|---|---|---|
| BWP-DownlinkDedicated | :: = | SEQUENCE { |
| groupIDBitMap | :: = | BIT STRING |

(SIZE (maxGroupID) )
}
cellGroupID Indicate which cell group belongs to
groupIDList : Indicate which BWP group it belongs to

In one implementation, for the cell A, for the BWP1A, it may indicate BWP group ID ½ to the UE.

In another implementation, for the BWP 3A, it may indicate BWP group ID 3 to the UE. Meanwhile, it may indicate cell group ID 1 to the UE.

In another implementation, the same logic may also be adopted for cell B/C/D, the group ID/cell group ID can also start with 0.

In some implementations, the above example is from the BWP perspective, it may also be configured from the group ID perspective.

Another example for BWP group definition in method 3 is described. An index is given to each possible BWP groups. Taking the above BWP configuration, an example may be as below:

$$BWPConfig ⇒ [ \begin{matrix}C e l l A & C e l l B & C e l l C \\ B W {P}_{1 A} & B W {P}_{1 B} & B W {P}_{1 C} \\ B W {P}_{2 A} & B W {P}_{2 B} & B W {P}_{2 C} \\ B W {P}_{3 A} & B W {P}_{3 B} & B W {P}_{3 C}\end{matrix} ]$$

In this example, there may be 4*4*4=64 possible BWP configurations, so that in the group ID, there would be 6 bits, 2 bits for each cell. For example but not limited to, 2 bits of 00 may indicate no BWP for the corresponding cell; 2 bits of 01 may indicate the first BWP for the corresponding cell; 2 bits of 10 may indicate the second BWP for the corresponding cell; and/or 2 bits of 11 may indicates the third BWP for the corresponding cell.

In another example, when there are 4 BWPs, there may be 3 bits for each cell.

Another example is described in Table 5.

TABLE 5
BWP Groups

| Group ID | Cell A | Cell B | Cell C |
|---|---|---|---|
| 000000 | N/A | N/A | N/A |
| 000001 | N/A | N/A | BWP 1C |

. . .

| | | | |
|---|---|---|---|
| 000101 | N/A | BWP 1B | BWP 1C |

. . .

| | | | |
|---|---|---|---|
| 100111 | BWP 2A | BWP 1B | 3C |

. . .

In various embodiments, the method 400 or 500 may further include determining, by the base station, the target BWP group; and/or sending, by the base station, a message comprising a BWP group indication field to the UE, the BWP group indication field indicating at least one target BWP group ID.

In one implementation, the message comprising at least one of the following: downlink control information (DCI), a medium access control (MAC) control element (CE), or RRC signaling.

In another implementation, the DCI comprises a first DCI format comprising at least one BWD group indication group.

In another implementation, the DCI comprises a second DCI format comprising a BWD group indication field for each cell group.

In another implementation, the DCI comprises a third DCI format comprising, for each cell group, a pair of a cell group index and a corresponding BWD group indication field.

In another implementation, in response to the target BWP group comprising no BWP for a cell and an activated BWP being on the cell, the UE performs at least one of the following: keeping the activated BWP on the cell; or deactivating the activated BWP on the cell.

In another implementation, the MAC CE comprises a first MAC CE format the BWD group indication group.

In another implementation, the MAC CE comprises a second MAC CE format comprising, for each cell group, a pair of a cell group index and a corresponding BWD group indication field.

In another implementation, the MAC CE comprises a third MAC CE format comprising a BWD group indication field for each cell group.

In another implementation, in response to the target BWP group comprising no BWP for a cell and an activated BWP being on the cell, the UE performs at least one of the following: keeping the activated BWP on the cell; or deactivating the activated BWP on the cell.

In another implementation, the method 400 or 500 may further include configuring, by the base station, a timer for at least one BWP group, so that in response to the timer expiring, the UE falls back to a default BWP or a default BWP group.

In another implementation, the timer is configured for at least one BWP groups.

In another implementation, the timer is configured for at least one of the following: all of the at least one BWP groups, each of the at least one BWP groups respectively, or a partial set of the at least one BWP groups.

In another implementation, the method 400 or 500 may further include sending, by the base station, a message comprising a list of a target BWP ID for each cell, so that the UE switches to the list of the target BWP ID for each cell.

In another implementation, the message comprising at least one of the following: downlink control information (DCI), a medium access control (MAC) control element (CE), or RRC signaling.

In various embodiments, the network may switch a group of the BWP simultaneously by a DCI, a MAC CE, or a RRC signaling.

In one implementation, the DCI/MAC CE include a BWP Group indication field for at least one of the following: the BWP Group indication field indicates the group ID, or is an index of the group ID; the UE determines the related BWPs according to the received BWP group configuration and the index of the group ID; and/or the UE switches to the BWP group according to the index of the group ID.

In another implementation, for the BWP group definition and/or configuration in one or more embodiments discussed above, the DCI/MAC CE further includes the cell group information explicitly or implicitly.

In another implementation, the UE determines the related BWPs and related Cell Group according to the received BWP group configuration and the index of the group ID/Cell group information.

In another implementation, the UE switches to the BWP group of the corresponding cell group.

In another implementation, the network configure a timer for all of the BWP groups or for each BWP group. In one implementation, the timer may be an inactive timer (e.g., bwpGroup-InactivityTimer).

In another implementation, once the timer expires, the UE falls back to the default Bandwidth Part (or default BWP group if defined).

In another implementation, the network may also switch a group of BWP by indicating the BWP ID list in the DCI/MAC CE explicitly.

One example for a group based BWP switch through DCI is described. This example may be an example for at least one of the above definition/Configuration method, for example, methods 1 and/or 3.

In one implementation, the DCI format may include . . . |BWP Group indication field|, wherein the BWP Group indication field indicates the group ID.

In another implementation, the length of the BWP Group indication field may equal to the bits length of the group ID. If the network wants to switch UE to a BWP group, the network indicates the Group ID in the DCI. At the UE side, the UE may determine which BWPs are included in this Group ID based on the previous configuration, then switch to the related BWPs.

Take the above Table 2 as an example, the network wants to switch the UE to the BWP group 2, the network indicates 2 in the BWP Group indication field of the DCI, then the UE may switch to BWP1A on cell A, BWP 2B on Cell B, and BWP 3C on cell C.

In another implementation, for the case that a cell has an activated BWP but no BWP of this cell is included in the indicated BWP Group, the system may use at least one of the following methods: Method 1: keeping the original activated BWP on this cell; and/or Method 2: De-activating the activated BWP of this cell. For example, when the network determines to switch the BWP group from group 2 to group 3, for the cell A, with method 1, the UE may keep BWP 1A as active, with method 2, the UE may de-activate BWP1A on the cell A.

In another implementation, the method may be configured by the network side by RRC signaling or DCI/MAC CE.

Another example for a group based BWP switch through DCI. This example may be an example for at least one of the above definition/Configuration method, for example, method 2.

In one implementation, for a DCI format 1, the cell group information may be indicated implicitly as . . . |BWP Group indication field for the cell group 1∥BWP Group indication field for the cell group 2|.

In another implementation, for a DCI format 2, the cell group information may be indicated explicitly, and/or one or more cell group may be indicated in a DCI as . . . |cell group Index∥BWP Group indication field∥cell group Index∥BWP Group indication field|.

In another implementation, the above Table 3 and/or 4 may be used as example.

When the network wants to switch to Group 1 of the cell Group 1, the DCI format 1 may be as |BWP Group indication field for the cell group 1∥BWP Group indication field for the cell group2|=>|1∥absent or reserved value|; the DCI format 2 may be as |cell group Index∥BWP Group indication field|=>|1∥1|. In one implementation, |1| may refer to as 2 bits of 01.

When the network want to switch to Group 1 of the cell Group 1 and group 2 of the cell group 2, the DCI format 1 may be as |BWP Group indication field for the cell group 1∥BWP Group indication field for the cell group2|=>|1∥2|; and the DCI format 2 may be as |cell group Index∥BWP Group indication field∥cell group Index∥BWP Group indication field|=>|1∥1∥2∥2|. In one implementation, |2| may refer to as 2 bits of 10.

Another example for a group based BWP switch through MAC CE is described. This example may be an example for at least one of the above definition/Configuration method, for example, methods 1 and/or 3. This example is described based on the MAC CE, and the description is similar to a method based on the DCI.

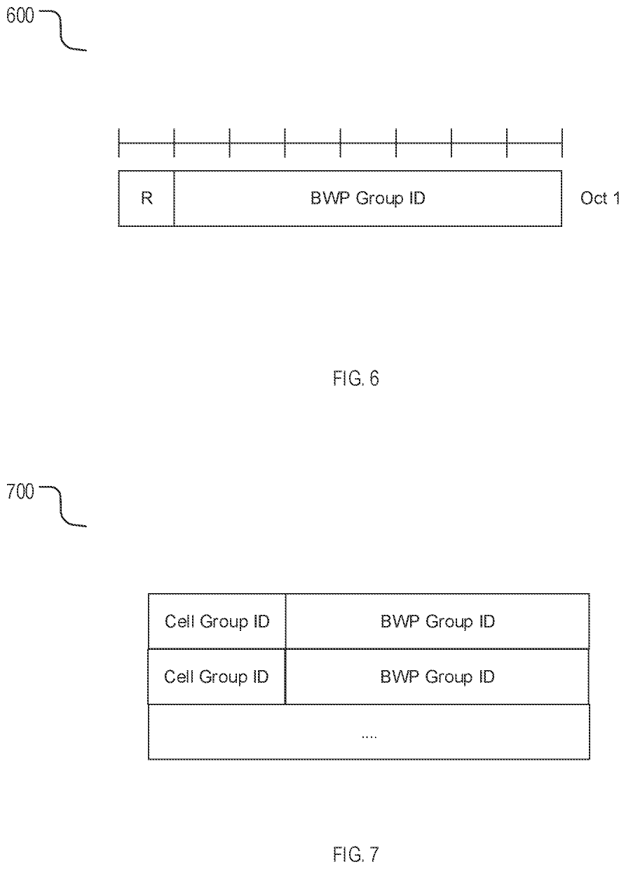

In one implementation, the BWP Group indication field indicates a group ID or is an index of the group ID. The length BWP Group indication field may equal to the bits length of the group ID. If the network want to switch UE to a BWP group, the network indicate the Group ID in a MAC CE 600 in FIG. 6.

In another implementation, at the UE side, the UE may determine which BWPs are included in this Group ID based on the previous configuration, then switch to the related BWPs.

In another implementation, taking the Table 2 as an example, the network wants to switch the UE to the BWP group 2, the network indicates 2 in the BWP Group indication field of the MAC CE, then the UE may switch the to BWP1A on cell A, BWP 2B on Cell B and BWP 3C on cell C.

In another implementation, for the case that a cell has an activated BWP but no BWP of this cell is included in the indicated BWP Group, the system may use at least one of the following methods: Method 1: keeping the original activated BWP on this cell; and/or Method 2: De-activating the activated BWP of this cell.

For example, when the network determines to switch the BWP group from group 2 to group 3, for the cell A, with method 1, the UE may keep BWP 1A as active; with method 2, the UE may de-activate BWP1A on the cell A.

In another implementation, the above method/example may be configured by the network side by a RRC signaling or DCI/MAC CE.

Another example for a group based BWP switch through MAC CE is described. This example may be an example for at least one of the above definition/Configuration method, for example, method 2. This example is described based on the MAC CE, and the description is similar to a method based on the DCI.

In one implementation, referring to FIG. 7, the MAC CE format 1 (700) may indicate the cell group ID explicitly. The cell group ID indicate the cell group, while the BWP group ID indicate the BWP group ID of the related cell group.

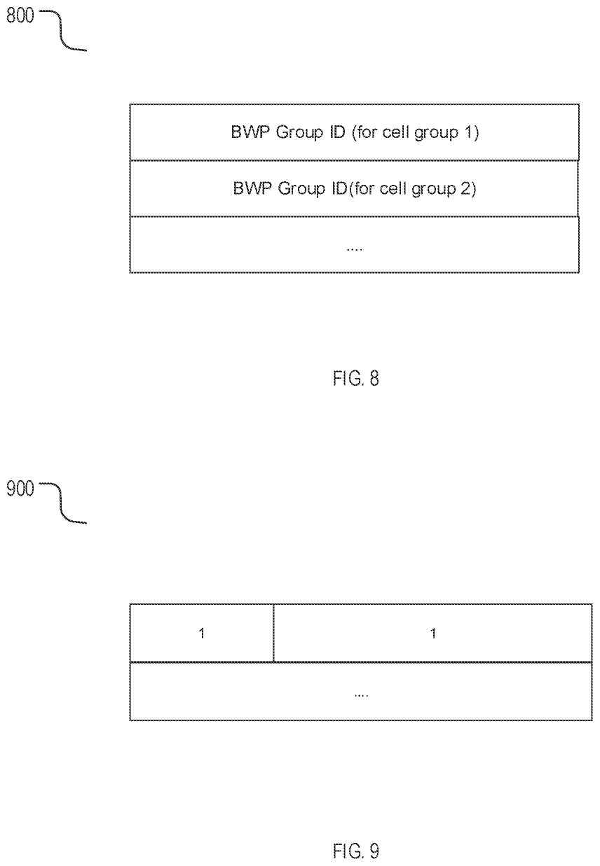

In another implementation, referring to FIG. 8, the MAC CE format 2 (800) may indicate the cell group ID implicitly.

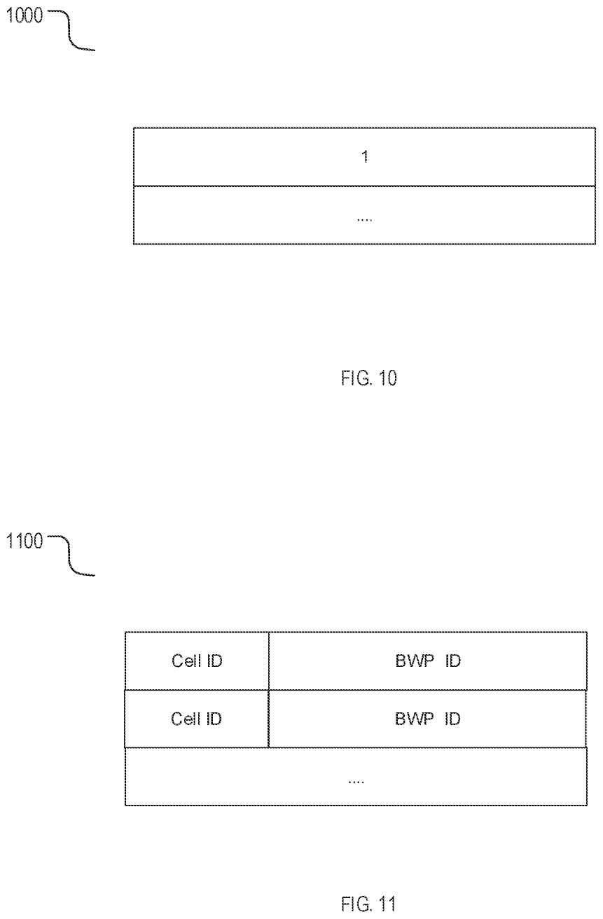

In another implementation, taking the above Table 3 and/or 4 as an example, when the network wants to switch to Group 1 of the cell Group 1, the MAC CE Format 1 (900) may be as shown in FIG. 9; and the MAC CE Format 2 (1000) may be as shown in FIG. 10.

Another example for a network switching a group of BWP by indicating the BWP ID list explicitly. This example, as shown in FIG. 11, is described based on the MAC CE with a MAC CE format (1100), and the description is similar to a method based on the DCI.

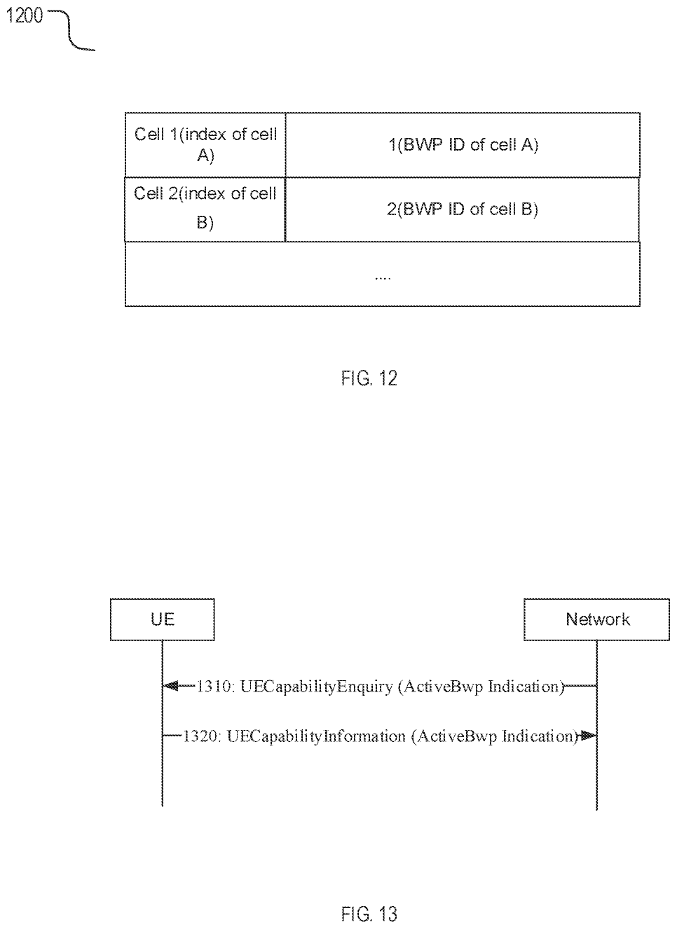

For example, when the network wants to switch the UE to BWP 1A of Cell A and BWP 2B of cell B, the network may set the MAC CE (1200) as shown in FIG. 12.

In one implementation, at the UE side, upon receiving this MAC CE, the UE may switch to BWP 1A of Cell A and BWP 2B of cell B.

Another example for configuring a timer for at least one BWP group.

In one implementation, the network may configure a timer (e.g., bwpGroup-InactivityTimer) for part of the BWP groups, all of the BWP groups, or for each BWP group.

In another implementation, the UE may start the corresponding bwpGroup-InactivityTimer, once the timer expires, the UE falls back to the default Bandwidth Part (or default BWP group if defined).

In one implementation, the bwpGroup-InactivityTimer may be configured for all of the BWP groups.

RRCConnectionReconfiguration :: = SEQUENCE
{
. . . .
bwpGroup-InactivityTimer ENUMERATED {ms2,
ms3, ms4, ms5, ms6, ms8, ms10, ms20, ms30,ms40,ms50,
ms60, ms80,ms100, ms200,ms300, ms500, ms750, ms1280,
ms1920, ms2560, spare10, spare9, spare8,spare7, spare6,
spare5, spare4, spare3, spare2, spare1 } OPTIONAL,
--Need R
}
bwpGroup-InactivityTimer
The duration in ms after which the UE falls back to the default Bandwidth Part (or
default BWP group). When the network releases the timer configuration, the UE
stops the timer without switching to the default BWP.

In one implementation, the bwpGroup-InactivityTimer may be configured for each of the at least one BWP groups respectively, or a partial set of the at least one BWP groups.

The present disclosure describes various embodiment for Further Enhancement of BC capabilities for the active BWPs reporting.

In one implementation, the UE reports the BC capabilities for the active BWPs: the BC capabilities for the active BWPs may define the requirements that all of the possible combinations of the active BWPs may satisfy; and/or the network includes an active BWP indication in the UE capability require message, and/or at the UE side, the UE includes active BWP indication when report the UE capability.

In another implementation, the network may configure more aggressive BWPs, and define active BWP groups based on the BC capabilities for the active BWPs, the network may switch the UE to BWPs in a certain active BWP group simultaneously by DCI or MAC CE as in one or more embodiments describes above.

One example, referring to FIG. 13, for a UE capability transfer with active BWP flag procedure is described.

At UE side, when ActiveBwp Indication is received in the UECapabilityEnquiry message (1310), the UE may report the BC capabilities for the active BWPs (1320). In one implementation, the UE may also include the ActiveBwp indication in the UECapabilitylnformation message.

Another example for UE capability enquiry message with active BWP flag is described as below:

UECapabilityEnquiry ::= SEQUENCE {
activeBwpIndication ENUMERATED
{enabled} OPTIONAL, -- Need N
}
activeBwpIndication:
If this field is present, the UE shall report the BC capabilities for the Active BWPs

Another example for UE capability information message with active BWP flag is described as below:

UECapabilityInformation :: = SEQUENCE {
activeBwpIndication ENUMERATED
{enabled} OPTIONAL, -- Need N
}
activeBwpIndication:
The UE include this indication when report the BC capabilities for the Active
BWPs.

In one implementation, the network may also indicate the ActiveBwp for one or more dedicated RATs, such as EN-DC/NE-DC/NR-DC/NR-CA. For one example, when ActiveBwp is set only for the NR-DC, the UE may report the NR-DC BC capabilities for the Active BWP, while for other RATs, it may report BC capabilities for the configured BWP.

The present disclosure describes methods, apparatus, and computer-readable medium for wireless communication. The present disclosure addressed the issues with configuring group-based bandwidth part (BWP) switch. The methods, devices, and computer-readable medium described in the present disclosure may facilitate the performance of wireless transmission, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1-23. (canceled)

24. A method for wireless communication, comprising:
receiving, by a user equipment (UE), a configuration comprising at least one bandwidth part (BWP) group from a base station, wherein each BWP group of the at least one BWP group comprises at least one BWP of at least one cell in a band combination (BC); and
configuring, by the UE, the configuration received from the base station.

25. The method according to claim 24, further comprise:
receiving, by the UE, a first active group BWP ID; and
switching, by the UE, to a first active BWP group based on the first active group BWP ID.

26. The method according to claim 24, wherein:
the at least one BWP group comprises a default BWP group.

27. The method according to claim 24, wherein:
for a BWP group of the at least one BWP group, the base station configures a BWP group identifier (ID) corresponding to the BWP group comprising at least one BWP.

28. The method according to claim 24, wherein:
for a BWP, the base station configures that the BWP belongs to at least one BWP group ID corresponding to a BWP group of the at least one BWP group

29. The method according to claim 28, wherein:
the at least one BWP in the BWP group ID corresponds to a same cell group comprising at least one of a master cell group (MCG) or a secondary cell group (SCG).

30. The method according to claim 24, wherein:
the UE receives at least one cell group configuration; and
for each cell group of the at least one cell group, the UE receives at least one BWP group corresponding to the each cell group of the at least one cell group.

31. The method according to claim 24, wherein:
the UE determines each BWP group implicitly of the at least one BWP group configuration.

32. The method according to claim 24, further comprising:
receiving, by the UE, a message comprising a BWP group indication field from the base station, the BWP group indication field indicating at least one target BWP group ID;
determining, by the UE, target BWP group according to the configuration and the target group ID; and
switching to, by the UE, the target BWP group according to the target group ID.

33. The method according to claim 32, wherein:
the message comprising at least one of the following:
downlink control information (DCI),
a medium access control (MAC) control element (CE), or RRC signaling.

34. The method according to claim 33, wherein:
the DCI comprises a first DCI format comprising at least one BWD group indication group.

35-41. (canceled)

42. The method according to claim 24, further comprising:
in response to a timer expiring, falling back to, by the UE, a default BWP or a default BWP group, wherein the timer is configured by the base station for at least one BWP group.

43. The method according to claim 42, wherein:
the timer is configured for at least one BWP groups.

44. The method according to claim 43, wherein:
the timer is configured for at least one of the following:
all of the at least one BWP groups,
each of the at least one BWP groups respectively, or
a partial set of the at least one BWP groups.

45. The method according to claim 24, further comprising:
receiving, by the UE, a message comprising a list of a target BWP ID for each cell; and,
switching, by the UE, to the list of the target BWP ID for each cell.

46. The method according to claim 45, wherein:
the message comprising at least one of the following:
downlink control information (DCI),
a medium access control (MAC) control element (CE), or RRC signaling.

47-48. (canceled)

49. An apparatus comprising:
a memory storing instructions; and
a processor in communication with the memory, wherein, when the processor executes the instructions, the processor is configured to cause the apparatus to perform:
receiving a configuration comprising at least one bandwidth part (BWP) group from a base station, wherein each BWP group of the at least one BWP group comprises at least one BWP of at least one cell in a band combination (BC); and
configuring the configuration received from the base station.

50. The apparatus according to claim 49, wherein, when the processor executes the instructions, the processor is configured to further cause the apparatus to perform:
receiving a first active group BWP ID; and
switching to a first active BWP group based on the first active group BWP ID.

51. A non-transitory computer program product comprising a computer-readable program medium storing instructions, wherein, the instructions, when executed by a processor, are configured to cause the processor to perform:
receiving a configuration comprising at least one bandwidth part (BWP) group from a base station, wherein each BWP group of the at least one BWP group comprises at least one BWP of at least one cell in a band combination (BC); and
configuring the configuration received from the base station.

52. The non-transitory computer program product according to claim 51, wherein the instructions, when executed by the processor, are configured to further cause the processor to perform:
receiving a first active group BWP ID; and
switching to a first active BWP group based on the first active group BWP ID.
